(19) United States
(12) Patent Application Publication
(10) Pub. No.: US 2024/0034294 A1
(43) Pub. Date: Feb. 1, 2024

(54) BRAKING SYSTEM FOR AN AT LEAST TWO-AXLE VEHICLE

(71) Applicant: Robert Bosch GmbH, Stuttgart (DE)

(72) Inventor: Dirk Mahnkopf, Eglosheim (DE)

(21) Appl. No.: 18/257,068

(22) PCT Filed: Dec. 9, 2021
(86) PCT No.: PCT/EP2021/084971

§ 371 Date: Jun. 12, 2023

(30) Foreign Application Priority Data
Dec. 18, 2020 (DE) 10 2020 216 321.9

(51) Int. Cl. B60T 13/74; B60T 13/66

(52) U.S. Cl. CPC B60T 13/745; B60T 13/662; B60T 2270/404

(57) ABSTRACT

A braking system for an at least two-axle vehicle. The braking system includes: a front axle unit including a first motorized brake pressure buildup device, a front-wheel wheel-brake cylinder mountable at a first front wheel, and a second front-wheel wheel-brake cylinder mountable at a second front wheel; and a rear axle unit hydraulically separate from the front axle unit, including a second motorized brake pressure buildup device, a first rear-wheel wheel-brake cylinder mountable at a first rear wheel, and a second rear-wheel wheel-brake cylinder mountable at a second rear wheel. The second motorized brake pressure buildup device is hydraulically connected via a first rear-axle hydraulic path at the first rear-wheel wheel-brake cylinder and via a second rear-axle hydraulic path at the second rear-wheel wheel-brake cylinder. A first separating valve is situated in the first rear-axle hydraulic path and/or a second separating valve is situated in the second rear-axle hydraulic path.

### FIELD

The present invention relates to a braking system for an at least two-axle vehicle. The present invention also relates to a method for operating a braking system of an at least two-axle vehicle.

### BACKGROUND INFORMATION

Braking systems for vehicles with at least two axles are described in the related art such as, for example, in German Patent Application No. DE 10 2016 208 529 A1, which include in each case four wheel brake cylinders, each wheel brake cylinder being hydraulically connected at a main brake cylinder of the respective braking system to a brake pedal situated upstream from the main brake cylinder.

### SUMMARY

The present invention provides a brake cylinder for an at least two-axle vehicle and a method for operating a braking system of an at least two-axle vehicle.

The present invention provides braking systems for at least two-axel vehicles that have a comparatively compact design and are producible at relatively low manufacturing costs. As will become clear based on the following description, the conventional hydraulic lines between the at least two axles of the respective vehicle equipped with the braking system are omitted in a braking system according to the present invention. This produces a savings of a relatively large amount of installation space on the respective vehicle. This also facilitates a mounting of the braking system according to the present invention on the respective vehicle.

As also becomes clear based on the following description, it is possible in a braking system according to the present invention to fully automatically/fully autonomously set the respective brake pressure in its front-wheel wheel-brake cylinders and in its rear-wheel wheel-brake cylinders, i.e., without a driver braking force being provided by a driver. This may also be referred to as a fully automatic/fully autonomous pressure setting, which is possible for all wheel brake cylinders of the braking system according to the present invention.

In addition, according to an example embodiment of the present invention, at least the respective brake pressure in the rear-wheel wheel-brake cylinders of the braking system according to the present invention may be set individually. This may also be described as a wheel-specific fully automatic/fully autonomous pressure setting at least in the rear-wheel wheel-brake cylinders of the braking system according to the present invention. It is noted, however, that a switching of the valves of the braking system according to the present invention at least in the rear-wheel wheel-brake cylinders for the wheel-specific, fully automatic/fully autonomous pressure setting at least in the rear-wheel wheel-brake cylinders of the braking system according to the present invention is generally necessary only for a modulation such as, for example, an ESP control or ABS control. For this reason, valve switching noises occur relatively seldom during an operation of the braking system according to the present invention. Reference is therefore also made to a good noise vibration harshness (NVH) characteristic of the braking system according to the present invention.

In one advantageous specific embodiment of the braking system of the present invention, a rear-axle control device of the rear axle unit is designed and/or programmed, while taking into account at least one braking setpoint signal, which is output by at least one brake actuator sensor of the vehicle to the rear-axle control device by an automatic speed control system of the vehicle, by a front-axle control device of the front axle unit and/or by a further stabilizing device of the braking system, to activate the at least one second motorized brake pressure buildup device, the first separating valve and/or the second separating valve, so that at least temporarily, while at least the first separating valve is directed into its closed position, brake fluid is transferable via the second rear-axle hydraulic path into the second rear-wheel wheel-brake cylinder with the aid of an operation of the at least one second motorized brake pressure buildup device, and/or while at least the second separating valve is directed into its closed state, brake fluid is transferable via the first rear-axle hydraulic path into the first rear-wheel wheel-brake cylinder with the aid of the operation of the at least one second motorized brake pressure buildup device. A wheel-specific pressure setting is thus implementable in both rear-wheel wheel-brake cylinders of the specific embodiment of the braking described herein with the aid of the operation of the at least one second motorized brake pressure buildup device activated by the rear-axle control device. Alternatively, the rear axle unit may also be operated while the first separating valve and the second separating valve are open.

According to an example embodiment of the present invention, the rear axle unit is preferably designed to be hydraulically separate from the front axle unit in such a way that the rear axle unit and the front axle unit are connected to one another at most via one signal line and/or bus line connected at the rear-axle control device and/or at the front-axle control device. Thus, the conventional hydraulic lines between a front axle and a rear axle of the vehicle equipped with the braking system described herein are omitted in the specific embodiment of the braking system described herein.

For example, the first front-axle hydraulic path and the second front-axle hydraulic path may extend through a shared front-axle brake circuit of the front axle unit and/or the first rear-axle hydraulic path and the second rear-axle hydraulic path may extend through a shared rear-axle brake circuit of the rear axle unit. Alternatively, however, the first front-axle hydraulic path may also extend through a first front-axle brake circuit of the front axle unit while the second front-axle hydraulic path extends through a second front-axle brake circuit of the front axle unit and/or the first rear-axle hydraulic path may extend through a first rear-axle brake circuit of the rear axle unit, while the second rear-axle hydraulic path extends through a second rear-axle brake circuit of the rear axle unit. Thus, a high degree of design freedom is possible in the design of the brake circuits of the braking system.

According to an example embodiment of the present invention, the front axle unit preferably also includes at least one first front-axle separating valve situated in the first front-axle hydraulic path and/or a second front-axle separating valve situated in the second front-axle hydraulic path. A wheel-specific pressure setting in this case is also possible in both front-axle wheel-brake cylinders.

As an advantageous refinement of the present invention, the front axle unit may also include a main brake cylinder, at which a brake actuator of the vehicle is connectable or is connected in such a way that at least one piston of the main brake cylinder delimiting at least one chamber of the main brake cylinder is adjustable with the aid of an actuation of the brake actuator by a driver of the vehicle, the at least one chamber of the main brake cylinder being hydraulically connected at the at least one first motorized brake pressure buildup device, at the first front-axle hydraulic path and/or at the second front-axle hydraulic path via at least one valveless or valve-equipped connecting line. Thus, with the aid of his/her driver braking force, the driver has the option of braking directly into the front-wheel wheel-brake cylinder in order in this way to also effectuate an (additional) brake pressure buildup in the front-wheel wheel-brake cylinder. The specific embodiment of the braking system described herein thus also includes a mechanical fall-back level.

According to an example embodiment of the present invention, the at least one first motorized brake pressure buildup device is preferably a plunger device and the at least one chamber of the main brake cylinder is hydraulically connected via the at least one connecting line at at least one plunger chamber of the plunger device, a respective opening of that least one connecting line at the at least one plunger chamber being designed in such a way that, if at least one adjustable plunger piston of the plunger device is present in its respective initial position, brake fluid is transferable out of the main brake cylinder through the at least one opening of the at least one connecting line into the plunger device, whereas, if the at least one adjustable plunger piston is moved out of its respective initial position, a brake fluid transfer out of the main brake cylinder through the at least one opening of the at least one connecting line into the plunger device is prevented with the aid of at least one sealing element attached at the at least one plunger piston and/or in the respective plunger chamber. Thus, during an operation of the plunger device, the main brake cylinder is automatically “decoupled” from the plunger device. Nevertheless, the specific embodiment of the braking system described herein is automatically transferred to its fall-back level in the case of a failure of the plunger device, in which the driver is able to brake into the front-wheel wheel-brake cylinder via the main brake cylinder and the plunger device with the aid of his/her driver braking force. A switching of a valve is therefore unnecessary for transferring the specific embodiment of the braking system described herein into the mechanical fall-back level.

Alternatively, according to an example embodiment of the present invention, at least one main brake cylinder decoupling valve may also be situated in the at least one connecting line. A transfer of the specific embodiment of the braking system described herein into its mechanical fall-back level is thus also possible by switching the at least one main brake cylinder decoupling valve.

The above=described advantages are also ensured when carrying out a corresponding method for operating a braking system of an at least two-axle vehicle. It is expressly noted that the method for operating a braking system of an at least two-axle vehicle may be refined in accordance with the specific embodiments of the braking system explained above.

### BRIEF DESCRIPTION OF THE DRAWINGS

Further features and advantages of the present invention are explained below with reference to the figures.

FIG. 1 schematically shows a representation of a first specific embodiment of the braking system according to the present invention.

FIG. 2 schematically shows a representation of a second specific embodiment of the braking system according to the present invention.

FIGS. 3 through 8 schematically show partial representations of further specific embodiments of the braking system of the present invention.

FIG. 9 shows a flowchart for explaining one specific embodiment of the method for operating a braking system of an at least two-axle vehicle, according to the present invention.

### DETAILED DESCRIPTION OF EXAMPLE EMBODIMENTS

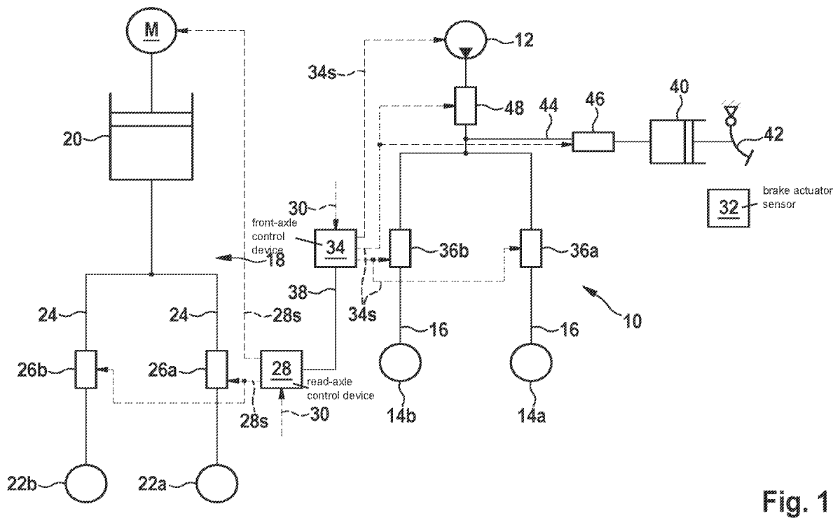

FIG. 1 schematically shows a representation of a first specific embodiment of the braking system.

The braking system schematically represented in FIG. 1 is mountable/is mounted at an at least two-axle vehicle/motor vehicle, a suitability of the braking system not being limited to any specific vehicle type/motor vehicle type of the two-axle vehicle/motor vehicle.

The braking system includes a front axle unit 10 that includes at least one first motorized brake pressure buildup device 12, a first front-wheel wheel-brake cylinder 14a mountable/mounted at a first front wheel of the vehicle and a second front-wheel wheel-brake cylinder 14b mountable/mounted at a second front wheel of the vehicle. The at least one first motorized brake pressure buildup device 12 is hydraulically connected at first front-wheel wheel-brake cylinder 14a via a first front-axle hydraulic path and at second front-wheel wheel-brake cylinder 14b via a second front-axle hydraulic path. Thus, in the braking system of FIG. 1, it is possible to fully automatically/fully autonomously set, i.e., without driver braking force being provided by a driver of the respective vehicle, a front wheel braking pressure in first front axle wheel-brake cylinder 14a and the same front-wheel braking pressure in second front axle wheel-brake pressure 14b with the aid of the at least one first motorized brake pressure buildup device 12. Merely by way of example, the first front-axle hydraulic path and the second front-axle hydraulic path in the specific embodiment of FIG. 1 extend through a shared front-axle brake circuit 16 of front axle unit 10. The design of the at least one first motorized brake pressure buildup device 12 visually depicted in FIG. 1 as at least one pump 12 is to be interpreted as merely exemplary. Instead of or in addition to the at least one pump 12, it is also possible to use a plunger device that includes at least one adjustable plunger piston as the at least one first motorized brake pressure buildup device 12 at the front axle unit 10.

The braking system also has a rear axle unit 18 designed to be hydraulically separate from front axle 10. Rear axle 18 includes at least one second motorized brake pressure buildup device 20, a first rear-wheel wheel-brake cylinder 22a mountable/mounted at a first rear wheel of the vehicle, and a second rear-wheel wheel-brake cylinder 22b mountable/mounted at a second rear wheel of the vehicle. The at least one second motorized brake pressure buildup device 20 is hydraulically connected via a first rear-axle hydraulic path at first rear-wheel wheel-brake cylinder 22a and via a second rear-axle hydraulic path at second rear-wheel wheel-brake cylinder 22b. For example, the first rear-axle hydraulic path and the second rear-axle hydraulic path in this case extend through a shared rear-axle brake circuit 24 of rear axle unit 18. In the example of FIG. 1, the at least one second motorized brake pressure buildup device 20 is a motorized plunger device 20, whose single adjustable plunger piston is adjustable with the aid of an operation of its motor. It is noted, however, that the design of the at least one first motorized brake pressure buildup device 20 as plunger device 20 including only the one adjustable plunger piston graphically depicted in FIG. 1 is to be interpreted as only exemplary. A plunger device that includes multiple adjustable plunger pistons or (instead of or in addition to a plunger device) at least one pump may also be used as the at least one second motorized brake pressure buildup device 20 at rear axle unit 18.

Rear axle unit 18 also includes a first separating valve 26a situated in the first rear-axle hydraulic path and/or a second separating valve 26b situated in the second rear-axle hydraulic path. In the braking system of FIG. 1, therefore, a first rear-wheel braking pressure in first rear-wheel wheel-brake cylinder 22a and a second rear-wheel brake pressure deviating from the first rear-wheel brake pressure in second rear-wheel wheel-brake cylinder 22b may be fully automatically/fully autonomously set with the aid of the at least one second motorized brake pressure buildup device 20 and with the aid of at least one of separating valves 26a and 26b. This may also be referred to as a wheel-specific fully automatic/fully autonomous pressure setting in the two rear-wheel wheel-brake cylinders 22a and 22b or as a wheel-specific fully automatic/fully autonomous brake pressure buildup in the two rear-wheel wheel-brake cylinders 22a and 22b.

It is noted, however, that such a wheel-specific fully automatic/fully autonomous pressure setting in rear-wheel wheel-brake cylinders 22a and 22b is generally only necessary for a modulation such as, for example, for an ESP control or ABS control. During a “standard operation” of rear axle unit 18, the same rear-wheel brake pressure is usually set in both rear-wheel wheel-brake cylinders 22a and 22b, so that no valve switching noises are able to occur. A driver of the vehicle is thus not irritated in such a situation by valve switching noises.

The hydraulically separate design of front axle unit 10 from rear axle unit 18 is understood to mean that no hydraulic line extends between front axle unit 10 and rear axle unit 18. Since front axle unit 10 is designed to be hydraulically separate from rear axle unit 18, the hydraulic lines traditionally required between the axles equipped with wheel brake cylinders 14a, 14b, 22a and 22b are omitted in the brake system of FIG. 1. The brake system thus has a very compact and space-saving design. A modular design of the brake system is, in particular, implementable at comparatively low manufacturing costs. Front axle unit 10 and rear axle unit 18 may also be mounted as two separate units at the two-axle vehicle equipped therewith. This also facilitates a mounting of the brake system described herein.

The at least one separating valve 26a and 26b may optionally be a switch valve or a continuously controllable valve suitable for differential pressure setting. The at least one separating valve 26a and 26b is preferably a normally open valve.

Rear axle unit 18 preferably also includes a rear-axle control device 28, which is designed and/or programmed to activate at least the at least one second motorized brake pressure buildup device 20, first separating valve 26a and/or second separating valve 26b with the aid of at least one control signal 28s while taking into account at least one brake setpoint signal 30. Rear-axle control device 28 is preferably designed to operate rear axle unit 18 at least temporarily in a mode in which brake fluid is transferable/is transferred via the second rear-axle hydraulic path into second rear-wheel wheel-brake cylinder 22b with the aid of an operation of the at least one second motorized brake pressure buildup device 20, while at least first separating valve 26a is controlled in its closed state and, if present, second separating valve 26b is controlled in an at least partially open state, so that an individual brake pressure increase takes place in second rear-wheel wheel-brake cylinder 22b. Alternatively or in addition, rear axle unit 18, with the aid of its rear-axle control device 28, may also be at least temporarily operable in a mode in which brake fluid is transferable/is transferred via the first rear-axle hydraulic path into first rear-wheel wheel-brake cylinder 22a with the aid of the operation of the at least one second motorized brake pressure buildup device 20 while at least second separating valve 26b is controlled in its closed state and, if present, first separating valve 26a is controlled in an at least partially open state, brake fluid is transferable/is transferred via the first rear-axle hydraulic path into first rear-wheel wheel-brake cylinder 22a with the aid of the operation of the at least one second brake pressure buildup device 20, which triggers an individual brake pressure increase in first rear-wheel wheel-brake cylinder 22a.

The at least one brake setpoint signal 30 may be output, for example, to rear-axle control device 28 by a brake actuator sensor 32 of the vehicle, by an automatic speed control system of the vehicle (not delineated), by an (optional) front-axle control device 34 of front axle unit 10 and/or by a further stabilizing device of the braking system (not shown). The at least one brake actuator sensor 32 may, for example, be a rod path sensor and/or a differential path sensor. The automatic speed control system may, for example, be an automatic system for driverless driving of the vehicle, an adaptive cruise control and/or an emergency braking system. The further stabilizing device of the vehicle may be understood to mean, in particular, an ESP control unit or an ABS control unit. Rear-axle control device 28 may thus interact with a plurality of different electronic components for pressure setting in rear-wheel wheel-brake cylinders 22a and 22b. As an advantageous refinement, rear-axle control unit 28 may also be designed to receive and to evaluate sensor signals of a pre-pressure sensor of rear axle unit 18 (not shown), of at least one wheel pressure sensor of rear axle unit 18 (not delineated) and/or of at least one wheel rotation sensor of the rear wheels (not graphically depicted). As a further advantageous refinement, rear-axle control device 28 may also be designed to also activate at least one generator-driven motor of the vehicle used for recuperative braking of the vehicle which, however, is not delineated in FIG. 1.

In the specific embodiment of FIG. 1, front axle unit 10 is designed to also include a first front-axle separating valve 36a situated in the first front-axle hydraulic path and/or a second front-axle separating valve 36b situated in the second front-axle hydraulic path. A wheel-specific fully automatic/fully autonomous pressure setting is thus also possible in the two front-wheel wheel-brake cylinders 14a and 14b. The at least front-axle separating valve 36a and 36b may optionally be a switch valve or a continuously controllable valve suitable for differential pressure setting. The at least one front-axle separating valve 36a and 36b is preferably a normally open valve. If front axle unit 10 is equipped with the at least one front-axle separating valve 36a and 36b, it preferably also includes front-axle control device 34, with the aid of which at least the at least one first motorized brake pressure buildup device 12, first front-axle separating valve 36a, and/or second front-axle separating valve 36b are activatable with the aid of at least one control signal 34s.

Rear axle unit 18 and front axle unit 10 are connected to one another at most via at least one signal line and/or bus line 38 connected at rear-axle control device 28 and at front-axle control device 34. The connection between rear axle unit 18 and front axle unit 10 implemented with the aid of signal line and/or bus line 38 is thus space-saving, yet still enables a good interaction between rear axle unit 18 and front axle 10. The at least one signal line and/or bus line 38 may, for example, be a vehicle bus of the vehicle.

In addition, front axle unit 10 in the specific embodiment of FIG. 1 advantageously also includes a main brake cylinder 40, at which a brake actuator 42 of the vehicle is connectable or is connected in such a way that at least one piston delimiting an at least one chamber of main brake cylinder 40 is adjustable/is adjusted with the aid of an actuation of brake actuator 42 by a driver of the vehicle. It is expressly noted that in this case, rear axle unit 18 is not hydraulically connected at main brake cylinder 40 of front axle unit 10.

Brake actuator 42 may, for example, be a brake pedal 42. Moreover, the at least one chamber of main brake cylinder 40 is hydraulically connected via at last one connecting line 44 at the at least one first motorized brake pressure buildup device 12, at the first front-axle hydraulic path, and/or at the second front-axle hydraulic path. Thus, at the braking system of FIG. 1, a mechanical fall-back level is formed, in which, in particular in the case of a failure of the at least one first motorized brake pressure buildup device 12 and/or the at least one second motorized pressure buildup device 20, the driver is still able to effectuate a brake pressure buildup in front-wheel wheel-brake cylinders 14a and 14b with the aid of his/her driver braking force applied to brake actuator 42. Thus, even in the case of a failure of the vehicle electrical power system of his/her vehicle, the driver is still able to reliably bring the vehicle to a standstill with the aid of the brake pressure increase effectuated in front-wheel wheel-brake cylinders 14a and 14b.

The at least one connecting line 44 may optionally be a valveless or valve-equipped connecting line 44. As an advantageous refinement, at least one main brake cylinder decoupling valve 46 may also be situated in the at least one connecting line 44. Thus, by closing the at least main brake cylinder decoupling valve 46, main brake cylinder 40 may be uncoupled from the at least one motorized brake pressure buildup device 12 during an operation of the at least one first motorized braking pressure buildup device 12 in such a way that the driver braking force applied to brake actuator 42 has no influence on the at least one front-wheel brake pressure present in front-wheel wheel-brake cylinders 14a and 14b. The at least one main brake cylinder decoupling valve 46 is preferably a normally open valve. Although not represented in FIG. 1, a simulator may also be connected at main brake cylinder 40, so that the driver actuating brake actuator 42 when the at least one main brake cylinder decoupling valve 46 is present in the closed state, has a standard brake actuation feel/pedal feel.

In addition, at least one brake pressure buildup device decoupling valve 48 may also be used in front-axle brake circuit 16 in such a way that the at least one first motorized brake pressure buildup device 12 is decouplable/is decoupled from the at least one connecting line 44 during the mechanical fall-back mode by closing the at least one brake pressure buildup device decoupling valve 48, and thus as a “volume sink,” does not adversely affect the brake pressure increase effectuated with the aid of the driver braking force in front-wheel wheel-brake cylinders 14a and 14b. For the at least one brake pressure buildup device decoupling valve 48, a normally closed valve is preferred.

In the braking system of FIG. 1, the only chamber of main brake cylinder 40 is connected via only one connecting line 44 to a single main brake cylinder decoupling valve 46 at front-axle brake circuit 16, an opening of the only connecting line 44 being located at front-axle brake circuit 16 between the at least one first motorized brake pressure buildup device 12 and a fork of front-axle brake circuit 16. Since the braking system of FIG. 1 has only a single brake pressure buildup device 12, only a single brake pressure buildup device decoupling valve 48 is also inserted into front axle unit 10. In this case, the opening of the only connecting line 44 is preferably located between the only brake pressure buildup device decoupling valve 48 and the fork of front-axle brake circuit 16.

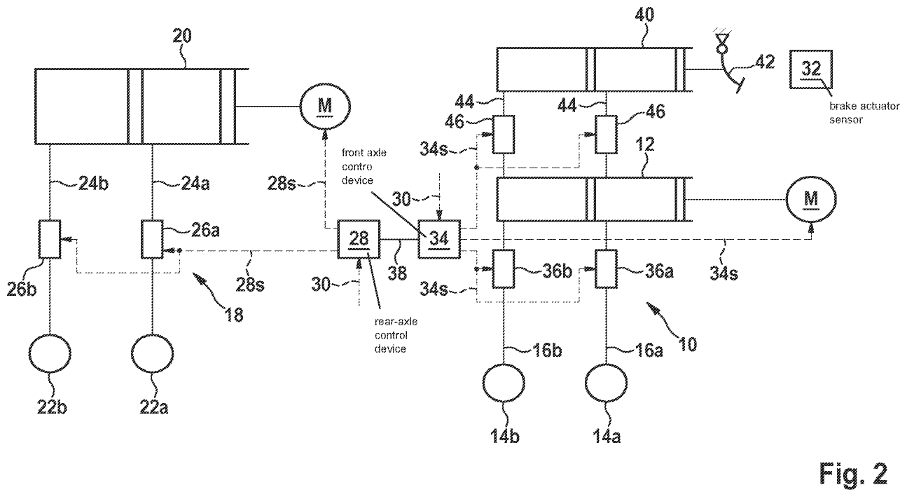

FIG. 2 schematically shows a representation of a second specific embodiment of the braking system.

In the braking system of FIG. 2, the at least one first motorized brake pressure buildup device 12 of front axle unit 10 is a first plunger device 12 including two plunger pistons that are adjustable with the aid of their motor. As a result, the first front-axle hydraulic path extends through a first front-axle brake circuit 16a of front axle unit 10 connected at a first plunger chamber of first plunger device 12, whereas the second front-axle hydraulic path extends through a second front-axle brake circuit 16b of front axle unit 10 connected at a second plunger chamber of first plunger device 12. Furthermore, main brake cylinder 40 connected at first plunger device 12 is a tandem main brake cylinder 40, a first chamber of main brake cylinder 40 with the first plunger chamber of first plunger device 12 and a second chamber of main brake cylinder 40 with the second plunger chamber of first plunger device 12 being connected via one connecting line 44 each to one main brake cylinder decoupling valve 46 each.

Moreover, the at least one second motorized brake pressure buildup device 20 in the braking system of FIG. 2 is designed as a second plunger device 20 including two adjustable plunger pistons. Accordingly, the first rear-axle hydraulic path extends through a first rear-axle brake circuit 24a of rear axle unit 18 connected at a first plunger chamber of second plunger device whereas the second rear-axle hydraulic path extends through a second rear-axle brake circuit 24b of rear axle unit 18 connected at a second plunger chamber of second plunger device 20.

With regard to further features of the braking system of FIG. 2 and their advantages, reference is made to the above-described specific embodiment of FIG. 1.

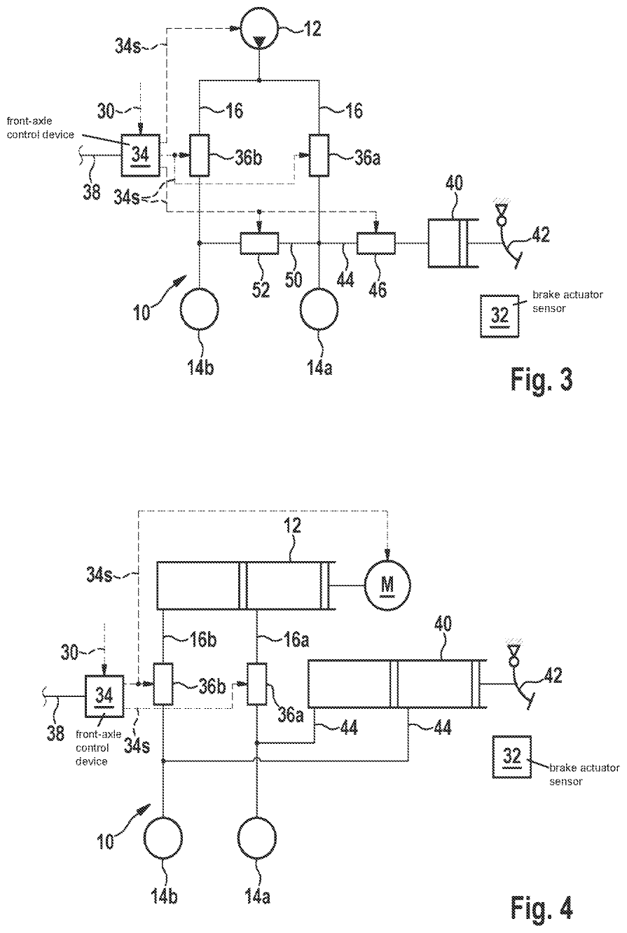

FIG. 3 schematically shows a partial representation of a third specific embodiment of the braking system.

Front axle unit 10 schematically shown in FIG. 3 differs from that represented in FIG. 1 in that the opening of connecting line 44 equipped with main brake cylinder decoupling valve 46 is located between first front-axle separating valve 36a and first front-wheel wheel-brake cylinder 14a. As an advantageous refinement, front axle unit 10 of FIG. 3 therefore also includes a brake circuit connecting line 50 using a switchable valve 52, the first opening of which is located between first front-axle separating valve 36a and first front-wheel wheel-brake cylinder 14a, and the second opening of which is located between second front-axle separating valve 36b and second front-wheel wheel-brake cylinder 14b. In the case of the braking system of FIG. 3 as well, the driver is still able to effectuate a brake pressure buildup in both front-wheel wheel-brake cylinders 14a and 14b in the mechanical fall-back level with the aid of his/her driver braking force applied to brake actuator 42. Switchable valve 52 is preferably a normally open valve.

With regard to further features of the braking system of FIG. 3 and their advantages, reference is made to the specific embodiment of FIG. 1. Rear axle unit 18 interacting with front axle unit 10 of FIG. 3 may, in particular, be designed in accordance with FIG. 1 or 2.

FIG. 4 schematically shows a partial representation of a fourth specific embodiment of the braking system.

In front axle unit 10 schematically represented in FIG. 4 (in contrast to the specific embodiment of FIG. 2), a first connecting line 44 connected at the first chamber of main brake cylinder 40 extends between first front-axle separating valve 36a and first front-wheel wheel-brake cylinder 14a, and a second connecting line 44 connected at the second chamber of main brake cylinder 40 extends between second front axle separating valve 36b and second front-wheel wheel-brake cylinder 14b. The two connecting lines 44 are valveless.

With regard to further features of the braking system of FIG. 4 and their advantages, reference is made to the specific embodiments of FIGS. 1 and 2. Rear axle unit 18 interacting with front axle unit 10 of FIG. 4 may, in particular, be designed in accordance with FIG. 1 or 2.

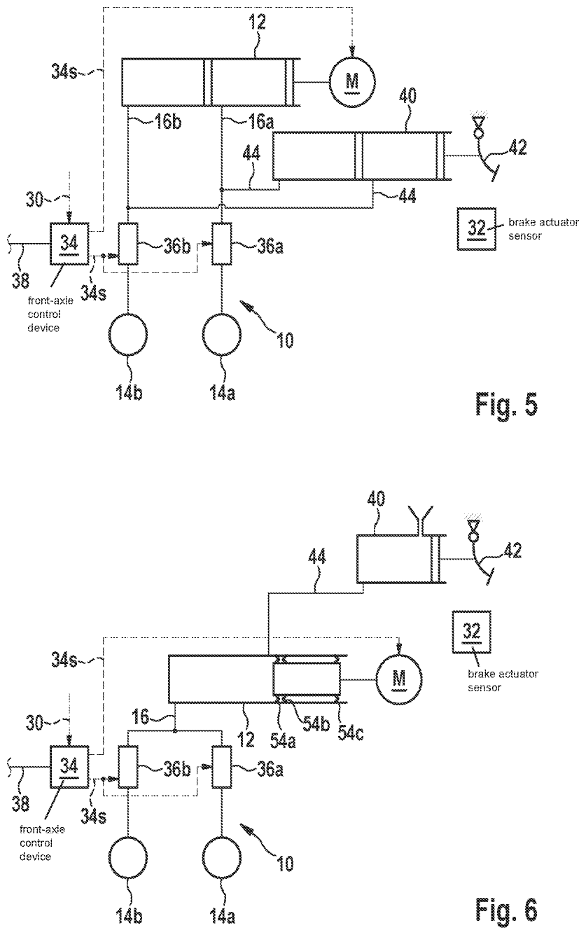

FIG. 5 schematically shows a partial representation of a fifth specific embodiment of the braking system.

In the case of front axle unit 10 schematically represented in FIG. 5, first connecting line 44 connected at the first chamber of main brake cylinder 40 extends, in contrast to the specific embodiment of FIG. 4, between the second plunger chamber of plunger device 12 and second front-axle separating valve 36b, and second connecting line 44 connected at the second chamber of main brake cylinder 40 extends between the first plunger chamber of plunger device 12 and first front-axle separating valve 36a.

With regard to further features of the braking system of FIG. 5 and their advantages, reference is made to the specific embodiments of FIGS. 1, 2, and 4. Rear axle unit 18 interacting with front axle unit 10 of FIG. 5 may, in particular, be designed in accordance with FIG. 1 or 2.

FIG. 6 schematically shows a partial representation of a sixth specific embodiment of the braking system.

In the case of front axle unit 10 schematically represented in FIG. 6, the at least one first motorized brake pressure buildup device 12 is a plunger device 12. The at least one chamber of main brake cylinder 40 of front axle unit 10 is hydraulically connected at the at least one plunger chamber of plunger device 12 via the at least one connecting line 44. A respective opening of the at least one connecting line 44 at the at least one plunger chamber is designed in such a way that, if at least one adjustable plunger piston of plunger device 12 is present in its respective initial position, brake fluid is transferable from main brake cylinder 40 into plunger device 12 through the at least one opening of the at least one connecting line 44. However, if the at least one adjustable plunger piston is moved from its respective initial position, a brake fluid transfer from main brake cylinder 40 through the at least one opening of the at least one connection line 44 into plunger device 12 is prevented with the aid of at least one sealing element 54a, 54b, and 54c attached at the at least one plunger piston and/or in the respective plunger chamber. The advantageously designed opening of the at least one connecting line 44 and the at least one sealing element 54a, 54b, and 54c attached at the at least one plunger piston and/or in the respective plunger chamber thus ensure that main brake cylinder is “automatically” uncoupled from plunger device 12 during an operation of plunger device 12 of main brake cylinder 40 present in its functional state, and thus the driver braking force applied to brake actuator 42 has no influence on the at least one front-wheel brake pressure present in front-wheel wheel-brake cylinders 14a and 14b. In the case of a failure of plunger device 12 and/or the vehicle electrical power system of the vehicle, the at least one adjustable plunger piston is generally present in its respective initial position, as a result of which the braking system is “automatically” transferred into its mechanical fall-back level, in which the driver is still able to reliably effectuate with the aid of his/her driver braking force a brake pressure increase in front-wheel wheel-brake cylinders 14a and 14b sufficient enough to decelerate his/her vehicle. Equipping the braking system of FIG. 6 with a main brake cylinder decoupling valve 46 is therefore unnecessary.

For example, the only chamber of main brake cylinder 40 in the brake system of FIG. 6 is connected via only one valveless connecting line 44 to the only plunger chamber of plunger device 12. The only plunger piston of plunger device 12 supports three sealing elements 54a, 54b, and 54c attached thereto. A first sealing element 54a located closest to connecting line 44 when the plunger piston is present in its initial position is blocking for a pressure from the direction of the opening and permeable for a pressure from the (opposite) direction of the motor. A second sealing element 54b adjacent to first sealing element 54a is permeable for a pressure from the direction of the opening and blocking for a pressure from the (opposite) direction of the motor. A third sealing element 54c located closest to the motor of plunger device 12 is also blocking for a pressure from the direction of the opening and permeable for a pressure from the (opposite) direction of the motor.

With regard to further features of the braking system of FIG. 6 and their advantages, reference is made to the above-explained specific embodiments. Rear axle unit 18 interacting with front axle unit 10 of FIG. 6 is designed, in particular, in accordance with FIG. 1 or 2.

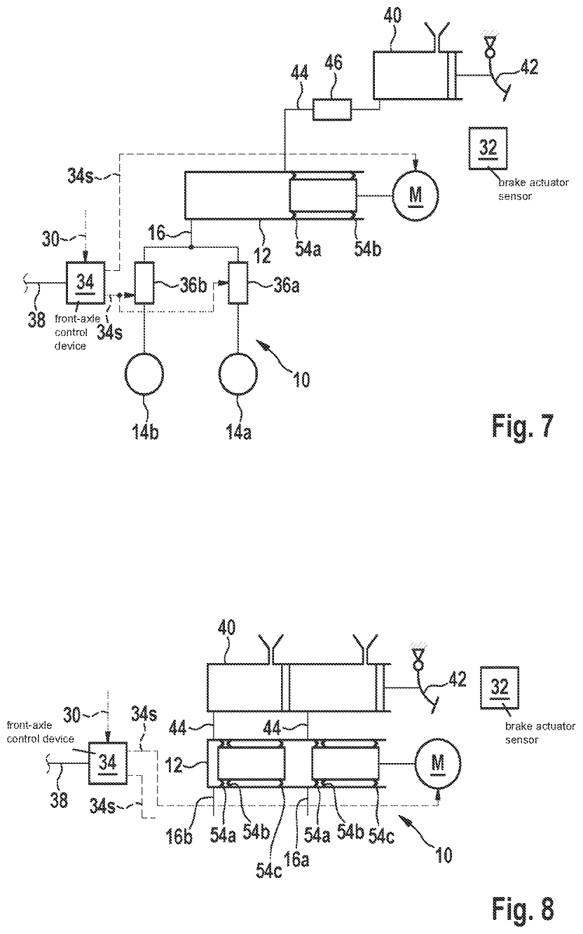

FIG. 7 schematically shows a partial representation of a seventh specific embodiment of the braking system.

In contrast to the specific embodiment of FIG. 6, “only” first sealing element 54a located in its initial position closest to the opening of connecting line 44, which is blocking for a pressure from the direction of the opening and permeable for a pressure from the (opposite) direction of the motor, and third sealing element 54c located closest to the motor of plunger device 12, which is also blocking for a pressure from the direction of the opening and permeable for a pressure from the (opposite) direction of the motor, are attached at the plunger piston in the braking system of FIG. 7. As a result, a main brake cylinder decoupling valve 46 is also situated in connecting line 44.

With regard to further features of the braking system of FIG. 7 and its advantages, reference is made to the above-explained specific embodiments. Rear axle unit 18 interacting with front axle unit 10 of FIG. 7 may, in particular, be designed according to FIG. 1 or 2.

FIG. 8 schematically shows a partial representation of an eighth specific embodiment of the braking system.

In front axle unit 10 reproduced in FIG. 8 as well, the first chamber of main brake cylinder 40 is connected to the first plunger chamber via a first connecting line 44 and the second chamber of main brake cylinder 40 is connected to the second plunger chamber via a second connecting line 44, the opening of each connecting line 44 at the plunger chamber assigned to them being designed in accordance with FIG. 6. Each of the two plunger pistons also supports sealing elements 54a, 54b, and 54c already described above.

With regard to further features of the braking system of FIG. 8 and their advantages, reference is made to the above-explained specific embodiments. Rear axle unit 18 interacting with front axle unit 10 of FIG. 8 may, in particular, be designed according to FIG. 1 or 2.

All of the braking systems described above require no new technology for their manufacture. Instead, it is possible to resort to already existing components/parts when manufacturing the braking systems described above.

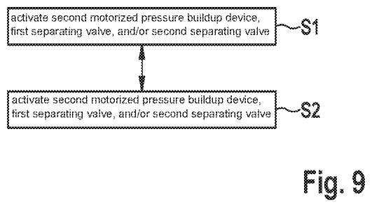

FIG. 9 shows a flowchart for explaining one specific embodiment of the method for operating a braking system of an at least two-axle vehicle.

The method described below is implementable with any braking system that includes a front axle unit including at least one first motorized brake pressure buildup device, which is hydraulically connected via a first front-axle hydraulic path at a first front-wheel wheel-brake cylinder of a first front wheel of the vehicle and via a second front-axle hydraulic path at a second front-wheel wheel-brake cylinder of a second front wheel of the vehicle, and a rear axle unit designed to be hydraulically separate from the front axle unit, including at least one second motorized brake pressure buildup device, which is hydraulically connected via a first rear-axle hydraulic path at a first rear-wheel wheel-brake cylinder of a first rear wheel of the vehicle and via a second rear-axle hydraulic path at a second rear-wheel wheel-brake cylinder of a second rear wheel of the vehicle. A feasibility is limited neither to a particular type of braking system nor to a specific vehicle type/motor vehicle type of the vehicle/motor vehicle equipped with the braking system.

As at least one of method steps S1 and S2, the at least one second motorized brake pressure buildup device, a first separating valve situated in the first rear-axle hydraulic path, and/or a second separating valve situated in the second rear-axle hydraulic path are activated taking at least one brake setpoint signal into account. The at least one brake setpoint signal is output by at least one brake activation element sensor of the vehicle, at least one automatic speed control system of the vehicle, at least one front-axle control device of the front axle unit and/or at least one further stabilizing device of the braking system. As a method step S1, the at least one second motorized brake pressure buildup device, the first separating valve and/or the second separating valve are activated in such a way that at least temporarily, while at least the first separating valve is directed into and/or held in its closed position, brake fluid is transferable via the second rear-axle hydraulic path into the second rear-wheel wheel-brake cylinder with the aid of an operation of the at least one second motorized brake pressure buildup device. Alternatively or in addition, as method step S2, the at least one second motorized brake pressure buildup device, the first separating valve and/or the second separating valve are activated in such a way that, at least temporarily, while the at least second separating valve is directed into and/or held in its closed state, brake fluid is transferred via the first rear-axle hydraulic path into the first rear-wheel wheel-brake cylinder with the of the operation of the at least one second motorized brake pressure buildup device. An implementation of the method described herein yields the advantages already enumerated above. Optionally, it is possible in a non-delineated method step to actuate the at least one second motorized braking pressure buildup device when the first separating valve is open and when the second separating valve is open.

All of the front axle units and rear axle units described above may be used to carry out the method described herein. A feasibility of the method is, however, not limited to the use of these front axle units and rear axle units.

1-10. (canceled)

11. A braking system for an at least two-axle vehicle, comprising:
a front axle unit including at least one first motorized brake pressure buildup device, a first front-wheel wheel-brake cylinder mountable at a first front wheel of the vehicle, and a second front-wheel wheel-brake cylinder mounted at a second front wheel of the vehicle, the at least one first motorized brake pressure buildup device being hydraulically connected via a first front-axle hydraulic path at the first front-wheel wheel-brake cylinder and via a second front-axle hydraulic path at the second front-wheel wheel-brake cylinder;
a rear axle unit hydraulically separate from the front axle unit, the rear axle unit including at least one second motorized brake pressure buildup device, a first rear-wheel wheel-brake cylinder mountable at a first rear wheel of the vehicle, and a second rear-wheel wheel-brake cylinder mountable at a second rear wheel of the vehicle, the at least one second motorized brake pressure buildup device being hydraulically connected via a first rear-axle hydraulic path at the first rear-wheel wheel-brake cylinder and via a second rear-axle hydraulic path at the second rear-wheel wheel-brake cylinder; and
a first separating valve situated in the first rear-axle hydraulic path and/or by a second separating valve situated in the second rear-axle hydraulic path.

12. The braking system as recited in claim 11, wherein a rear-axle control device (28) of the rear axle unit is configured to activate, taking into account at least one braking setpoint signal which is output to the rear-axle control device by at least one brake actuator sensor of the vehicle, and/or by an automatic speed control system of the vehicle, and/or by a front-axle control device of the front axle unit, and/or by a further stabilizing device of the braking system, the at least one second motorized brake pressure buildup device and/or the first separating valve and/or the second separating valve, so that at least temporarily: i) while at least the first separating valve is directed into its closed position, brake fluid is transferable via the second rear-axle hydraulic path into the second rear-wheel wheel-brake cylinder using an operation of the at least one second motorized brake pressure buildup device, and/or ii) while at least the second separating valve is directed into its closed state, brake fluid is transferable via the first rear axle hydraulic path into the first rear-wheel wheel-brake cylinder using the operation of the at least one second motorized brake pressure buildup device.

13. The braking system as recited in claim 12, wherein the rear axle unit is hydraulically separate from the front axle unit in such a way that the rear axle unit and the front axle unit are connected to one another at most via at least one signal line and/or bus line connected at the rear-axle control device and at the front-axle control device.

14. The braking system as recited in claim 11, wherein: i) the first front-axle hydraulic path and the second front-axle hydraulic path extend through a shared front-axle brake circuit of the front axle unit, and/or ii) the first rear-axle hydraulic path and the second rear-axle hydraulic path extend through a shared rear-axle brake circuit of the rear axle unit.

15. The braking system as recited in claim 11, wherein: i) the first front-axle hydraulic path extends through a first front-axle brake circuit of the front axle unit and the second front-axle hydraulic path extends through a second front-axle brake circuit of the front axle unit, and/or ii) the first rear-axle hydraulic path extends through a first rear-axle brake circuit of the rear axle unit and the second rear-axle hydraulic path extends through a second rear-axle brake circuit of the rear axle unit.

16. The braking system as recited in claim 11, wherein the front axle unit also includes at least one first front-axle separating valve situated in the first front-axle hydraulic path, and/or a second front-axle separating valve situated in the second front-axle hydraulic path.

17. The braking system as recited in claim 11, wherein the front axle unit also includes a main brake cylinder, at which a brake actuator of the vehicle is connectable or is connected in such a way that at least one piston of the main brake cylinder delimiting at least one chamber of the main brake cylinder is adjustable using an actuation of the brake actuator by a driver of the vehicle, and the at least one chamber of the main brake cylinder being hydraulically connected via at least one valveless or valve-equipped connecting line at the at least one first motorized brake pressure buildup device, at the first front-axle hydraulic path and/or at the second front-axle hydraulic path.

18. The braking system as recited in claim 17, wherein the at least one first motorized brake pressure buildup device is a plunger device and the at least one chamber of the main brake cylinder is hydraulically connected via the at least one connecting line at at least one plunger chamber of the plunger device, and a respective opening of the at least one connecting line at the at least one plunger chamber being configured in such a way that, when at least one adjustable plunger piston of the plunger device is present in its respective initial position, brake fluid is transferable from the main brake cylinder through the at least one opening of the at least one connecting line into the plunger device, whereas, when the at least one adjustable plunger piston is moved out of its respective initial position, a brake fluid transfer out of the main brake cylinder through the at least one opening of the at least one connecting line into the plunger device is prevented using at least one sealing element attached at the at least one plunger piston and/or in the respective plunger chamber.

19. The braking system as recited in claim 17, wherein at least one main brake cylinder decoupling valve is situated in the at least one connecting line.

20. A method for operating a braking system of an at least two-axle vehicle, the braking system including a front axle unit that includes at least one first motorized brake pressure buildup device, which is hydraulically connected via a first front-axle hydraulic path at a first front-wheel wheel-brake cylinder of a first front wheel of the vehicle and via a second front-axle hydraulic path at a second front-wheel wheel-brake cylinder of a second front wheel of the vehicle, and a rear axle unit hydraulically separate from the front axle unit, the rear axle unit including at least one second motorized brake pressure buildup device which is hydraulically connected via a first rear-axle hydraulic path at a first rear-wheel wheel-brake cylinder of a first rear wheel of the vehicle and via a second rear-axle hydraulic path at a second rear-wheel wheel-brake cylinder of a second rear wheel of the vehicle, the method comprising the following steps:
activating the at least one second motorized brake pressure buildup device and/or a first separating valve situated in the first rear-axle hydraulic path and/or a second separating valve situated in the second rear-axle hydraulic path, taking at least one brake setpoint signal into account, which is output by at least one brake actuator sensor of the vehicle by an automatic speed control system of the vehicle and/or by a front-axle control device of the front axle unit and/or by a further stabilizing device of the braking system, so that, at least temporarily: i) while at least the first separating valve is directed into and/or is held in its closed state, brake fluid is transferred via the second rear-axle hydraulic path into the second rear-wheel wheel-brake cylinder using an operation of the at least one second motorized brake pressure buildup device, and/or ii) while the at least second separating valve is directed into and/or is held in its closed state, brake fluid is transferred via the first rear-axle hydraulic path into the first rear-wheel wheel-brake cylinder using the operation of the at least one second motorized brake pressure buildup device.
